(19) United States
(12) Patent Application Publication
(10) Pub. No.: US 2014/0308155 A1
(43) Pub. Date: Oct. 16, 2014

(54) METHOD FOR POLISHING ALLOY MATERIAL AND METHOD FOR PRODUCING ALLOY MATERIAL

(71) Applicant: FUJIMI INCORPORATED, Kiyosu-shi, Aichi (JP)

(72) Inventors: Hitoshi Morinaga, Kiyosu-shi (JP); Hiroshi Asano, Kiyosu-shi (JP); Maiko Asai, Kiyosu-shi (JP); Shogo Tsubota, Kiyosu-shi (JP); Kazusei Tamai, Kiyosu-shi (JP)

(21) Appl. No.: 14/359,495

(22) PCT Filed: Nov. 19, 2012
(86) PCT No.: PCT/JP2012/079912

§ 371 Date: May 20, 2014

(30) Foreign Application Priority Data
Nov. 25, 2011 (JP) 2011-257513
Feb. 1, 2012 (JP) 2012-020221

(51) Int. Cl. C09G 1/02

(52) U.S. Cl. CPC C09G 1/02
USPC 420/43; 216/38; 420/528; 420/529; 420/531; 420/537; 420/538; 420/540; 420/548; 420/550; 420/532; 420/541; 420/542; 420/546; 420/547; 420/34; 420/67; 420/477

(57) ABSTRACT

An efficient polishing method for polishing an alloy material to have an excellent mirror surface is provided. The alloy material contains a main component and 0.1% by mass or more of an element that has a Vickers hardness (HV) different from the Vickers hardness of the main component by 5 or more. A polishing composition used in the polishing method contains abrasive grains and an oxidant. The alloy material is preferably an aluminum alloy, a titanium alloy, a stainless steel, a nickel alloy, or a copper alloy. It is also preferable that the alloy material is subjected to preliminary polishing before being subjected to polishing in which the polishing composition is used.

### TECHNICAL FIELD

The present invention relates to a method for polishing an alloy material including a main component and an element having a hardness different from that of the main component by using a polishing composition containing abrasive grains and an oxidant and a method for producing an alloy material by using the polishing method.

### BACKGROUND ART

Alloys are generally eutectic mixtures of one metallic element and one or more other metallic elements or non-metallic elements such as carbon, nitrogen and silicon. In general, alloys are produced for the purpose of improving properties such as mechanical strength, chemical resistance, corrosion resistance, and heat resistance as compared with those of a pure metal. Aluminum alloys, among various alloys, are lightweight and have an excellent strength and therefore are used in various applications, for example, structural materials such as a building material and a container and transport equipment such as automobiles, ships and airplanes, as well as various electric appliances and electronic components.

Titanium alloys are not only lightweight but also excellent in corrosion resistance, and therefore are widely used for precision equipment, ornaments, tools, sports goods, medical parts, and the like. Stainless steels, which are iron-based alloys, and nickel alloys have an excellent corrosion resistance, and therefore are used in various applications such as structural materials and transport equipment, as well as tools, mechanical instruments and cooking utensils. Copper alloys are not only excellent in electric conductivity, heat conductivity, corrosion resistance and workability but also beautifully finished and therefore are widely used for ornaments, eating utensils, musical instruments, parts for electric materials, and the like.

Depending on applications, there is a need for mirror-finishing the surface of alloys. A mirror-finishing method includes painting and coating of the alloy surface. If mirror-finishing can be realized by polishing of the alloy surface, however, such polishing achieves an advantage over painting and coating. For example, polishing can provide a mirror surface superior to that obtained through painting and therefore requires no painting or coating step and no material to be used in such a step. In addition, the mirror surface by polishing has higher durability than the mirror surface by painting and therefore is maintained over a long period of time.

Conventionally, there have been attempts to mirror-finish and smooth a surface by polishing (see, for example, Patent Documents 1 and 2). Such methods, however, cannot effectively provide a higher quality mirror surface. In particular, when an alloy in which a main component and an element having a hardness different from that of the main component are mixed is polished, a difference in polishing speed is caused between a portion where the element is present and a portion where the element is not present. This difference in polishing speed causes various defects such as projections, depressions, or scrapes on the alloy surface after polishing. Accordingly, it has been difficult to highly mirror-finish the alloy by polishing.

### PRIOR ART DOCUMENTS

### Patent Documents

Patent Document 1: Japanese Laid-Open Patent Publication No. 01-246068
Patent Document 2: Japanese Laid-Open Patent Publication No. 11-010492

### SUMMARY OF THE INVENTION

### Problems that the Invention is to Solve

An objective of the present invention is to provide a method for effectively polishing an alloy material including a main component and an element having a hardness different from that of the main component to form an excellent mirror surface.

### Means for Solving the Problems

The present inventors have made intensive studies, and as a result, have found that, when an alloy including a main component and an element having a hardness different from that of the main component is polished using a polishing composition containing abrasive grains and an oxidant, the alloy surface is oxidized by the oxidant, a brittle oxide film having a high hardness is formed on the alloy surface, and that by polishing the film with abrasive grains, an excellent mirror surface with no surface defects can be obtained.

To achieve the foregoing objective, and one aspect of the present invention provides a method for polishing an alloy material including a main component and 0.1% by mass or more of an element having a Vickers hardness (HV) different from that of the main component by 5 or more. The method includes polishing a surface of the alloy material by using a polishing composition containing abrasive grains and an oxidant.

The alloy material is preferably at least one selected from an aluminum alloy, a titanium alloy, a stainless steel, a nickel alloy, and a copper alloy. The oxidant is preferably hydrogen peroxide, and the abrasive grains are preferably colloidal silica. Another aspect of the present invention provides a method for producing an alloy material, including a step of polishing an alloy material by using the above described method for polishing an alloy material.

### Effects of the Invention

According to the present invention, an alloy material including a main component and an element having a hardness different from that of the main component can be effectively polished to be formed into an excellent mirror surface.

### MODES FOR CARRYING OUT THE INVENTION

Hereinafter, one embodiment of the present invention will be described.

A polishing method of the present embodiment is a method for polishing an alloy material including a main component and an element having a hardness different from that of the main component by using a polishing composition containing abrasive grains and an oxidant.

The alloy material is an aluminum alloy, a titanium alloy, a stainless steel, a nickel alloy, a copper alloy, or the like. The alloy material is preferably an alloy including an element having a Vickers hardness significantly different from that of the main component. In particular, the surface hardness of an alloy including aluminum, which is low in hardness, and silicon, which is high in hardness, is easily made uniform by the oxidant in the polishing composition. Therefore, the polishing method of the present embodiment is particularly preferable for polishing the aluminum alloy. When the aluminum alloy is used, a particularly excellent polishing rate is achieved and an excellent mirror surface with gloss can be effectively obtained.

The element included in the alloy material is an element having a Vickers hardness (HV) different from that of the main component by 5 or more. Such an element is preferably included in the alloy material in 0.1% by mass or more. Specifically, the aluminum alloy includes silicon, iron, copper, manganese, magnesium, zinc, chromium, and the like in an amount of 0.1 to 10% by mass relative to that of aluminum. As such an aluminum alloy, for example, A1070, 1050, 1100, 1200, 2014, 2017, 2024, 3002, 2003, 3203, 3004, 3005, 3105, 4032, 4043, 4045, 4047, 5005, 5052, 5082, 5083, 5086, 5154, 5182, 5252, 5254, 5454, 5451, 5657, 6003, 6056, 6061, 6063, 6082, 6101, 6110, 6151, 6351, 7003, 7005, 7050, 7072, 7075 and 7178 specified in Japanese Industrial Standards (JIS) H4000 are known.

The titanium alloy includes aluminum, iron, vanadium, and the like in an amount of 3.5 to 30% by mass relative to that of titanium. As such a titanium alloy, for example, Ti-6Al-4V specified in Japanese Industrial Standards (JIS) H4600 is known. The stainless steel includes chromium, nickel, molybdenum, manganese, and the like in an amount of 10 to 50% by mass relative to that of iron. As such a titanium alloy, for example, SUS201, 303, 303Se, 304, 304L, 304NI, 305, 305JI, 309S, 310S, 316, 316L, 321, 347, 384, XM7, 303F, 303C, 430, 430F, 434, 410, 416, 420J1, 420J2, 420F, 420C and 631J1 specified in Japanese Industrial Standards (JIS) G4303 are known.

The nickel alloy includes iron, chromium, molybdenum, cobalt, and the like in an amount of 20 to 75% by mass relative to that of nickel. As such a nickel alloy, for example, NCF600, 601, 625, 750, 800, 800H, 825, NW0276, 4400, 6002 and 6022 specified in Japanese Industrial Standards (JIS) H4551 are known.

The copper alloy includes iron, lead, zinc, tin, and the like in an amount of 3 to 50% by mass relative to that of copper. As such a copper alloy, for example, C2100, 2200, 2300, 2400, 2600, 2680, 2720, 2801, 3560, 3561, 3710, 3713, 4250, 4430, 4621, 4640, 6140, 6161, 6280, 6301, 7060, 7150, 1401, 2051, 6711 and 6712 specified in Japanese Industrial Standards (JIS) H3100 are known.

The polishing composition for use in the polishing method of the present embodiment will now be described.

The polishing composition includes abrasive grains and an oxidant.

The oxidant is required to have a sufficient oxidation-reduction potential for oxidizing both of the main component and the element different from the main component included in the alloy. Examples of the oxidant include peroxide, persulfate, perchlorate, periodate, permanganate, and the like. Specific examples of the peroxide include hydrogen peroxide, peracetic acid, percarbonate, urea peroxide, and perchloric acid, as well as persulfate such as sodium persulfate, potassium persulfate and ammonium persulfate. Among them, persulfate and hydrogen peroxide are preferable from the viewpoint of the polishing rate, and hydrogen peroxide is particularly preferable from the viewpoints of the stability in an aqueous solution and environmental load.

The content of the oxidant in the polishing composition is preferably 0.02% by mass or more, more preferably, 0.03% by mass or more, and further preferably, 0.1% by mass or more. When the content of the oxidant is in the above range, generation of surface defects after polishing is suppressed.

The content of the oxidant in the polishing composition is preferably 15% by mass or less and more preferably 10% by mass or less. When the content of the oxidant is in the above range, not only the production cost of the polishing composition can be reduced, but also environmental load due to a treatment of the used polishing composition, namely, a waste liquid treatment can be reduced.

The abrasive grains are preferably made of silicon oxide, aluminum oxide, cerium oxide, zirconium oxide, titanium oxide, manganese oxide, silicon carbide, or silicon nitride. Among them, silicon oxide is preferable, colloidal silica or fumed silica is more preferable, and colloidal silica is particularly preferable. When such abrasive grains are used, a smoother polished surface can be obtained.

As the colloidal silica, any of surface-unmodified colloidal silica and surface-modified colloidal silica can be used. Since the surface-unmodified colloidal silica has a zeta potential close to 0 under acidic conditions, silica particles do not electrically repel one another and easily aggregate under acidic conditions. In contrast, in the case of colloidal silica that is surface-modified so as to have a relatively large negative zeta potential even under acidic conditions, silica particles strongly repel one another and are favorably dispersed even under acidic conditions, resulting in the improvement in storage stability of the polishing composition.

Examples of the surface-modified colloidal silica include colloidal silica in which an organic acid such as a sulfonic acid or a carboxylic acid is immobilized on the surface and colloidal silica, the surface of which is subjected to substitution with a metal oxide such as aluminum oxide. An organic acid is immobilized on colloidal silica by chemically binding a functional group of the organic acid to the surface of the colloidal silica. A sulfonic acid can be immobilized on colloidal silica by, for example, the method described in “Sulfonic acid-functionalized silica through quantitative oxidation of thiol groups”, Chem. Commun. 246-247 (2003). Specifically, a silane coupling agent having a thiol group, such as 3-mercaptopropyltrimethoxysilane, can be coupled to colloidal silica, and thereafter the thiol group is oxidized by hydrogen peroxide to thereby provide colloidal silica in which a sulfonic acid is immobilized on the surface. A carboxylic acid can be immobilized on colloidal silica by, for example, the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, a silane coupling agent including a photo-reactive 2-nitrobenzyl ester can be coupled to colloidal silica and then irradiated with light to thereby provide colloidal silica in which a carboxylic acid is immobilized on the surface. In addition, the surface of colloidal silica is subjected to substitution with aluminum oxide by adding an aluminum compound to colloidal silica to react with each other, by, for example, the method described in Japanese Laid-Open Patent Publication No. 6-199515. Specifically, an alkali aluminate can be added to colloidal silica and heated to thereby provide colloidal silica whose surface is subjected to substitution with aluminum oxide.

When the surface-modified colloidal silica is used, the pH of the polishing composition is preferably in a range from 0.5 to 4.5. The surface of the surface-modified colloidal silica has modifying groups, such as sulfo groups, present thereon. Therefore, when the pH of the polishing composition is in a range from 0.5 to 4.5, the surface-modified colloidal silica is stably dispersed in the polishing composition, resulting in a high polishing rate. Herein, from the viewpoint of the improvement in polishing rate, colloidal silica that is surface-modified by a sulfonic acid, among surface-modified colloidal silica, is particularly preferable.

When the surface-unmodified colloidal silica is used, the pH of the polishing composition is preferably in a range from 8.0 to 12.0. The surface of the surface-unmodified colloidal silica has hydroxyl groups present thereon. Therefore, when the pH of the polishing composition is in a range from 8.0 to 12.0, the colloidal silica is stably dispersed in the polishing composition, resulting in a high polishing rate.

The average particle size of the abrasive grains included in the polishing composition is preferably 5 nm or more, more preferably, 10 nm or more, and further preferably, 15 nm or more. When the average particle size of the abrasive grains is in the above range, the polishing rate of the alloy material is improved.

The average particle size of the abrasive grains included in the polishing composition is preferably 400 nm or less, more preferably, 300 nm or less, further preferably, 200 nm or less, and most preferably, 100 nm or less. When the average particle size of the abrasive grains is in the above range, a surface having low defects and small surface roughness is easily obtained. When abrasive grains having a large particle size remaining in the alloy material after polishing are problematic, abrasive grains not having a large particle size but having a small particle size are preferably used.

Herein, the average particle size of the abrasive grains can be calculated from a value measured as a specific surface area by a nitrogen adsorption method (BET method).

The content of the abrasive grains in the polishing composition is preferably 1% by mass or more, and more preferably, 2% by mass or more. When the content of the abrasive grains is in the above range, the polishing rate of the alloy by the polishing composition is improved.

The content of the abrasive grains in the polishing composition is preferably 50% by mass or less, and more preferably, 40% by mass or less. When the content of the abrasive grains is in the above range, not only the production cost of the polishing composition is reduced, but also a polished surface having few scratches is easily obtained. In addition, the amount of the abrasive grains remaining on the alloy surface after polishing is reduced to result in the improvement in cleanliness of the alloy surface.

The polishing composition may further include a pH adjuster for the purpose of controlling the polishing rate of the alloy material, the dispersibility of the abrasive grains, and the like.

The pH adjuster is selected from known acids, bases, or salts thereof. Specific examples of the acid include: inorganic acids such as hydrochloric acid, sulfuric acid, nitric acid, hydrofluoric acid, boric acid, carbonic acid, hypophosphorous acid, phosphorous acid and phosphoric acid; and organic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid and phenoxyacetic acid. From the viewpoint of the improvement in polishing rate, in particular, sulfuric acid, nitric acid and phosphoric acid are preferable among inorganic acids, and in particular, glycolic acid, succinic acid, maleic acid, citric acid, tartaric acid, malic acid, gluconic acid and itaconic acid are preferable among organic acids. Specific examples of the base include organic bases such as an amine and quaternary ammonium hydroxide and hydroxides of alkali metals, hydroxides of alkali earth metals and ammonia.

In addition, a salt such as an ammonium salt or an alkali metal salt of the acid may be used as the pH adjuster instead of the acid or in combination with the acid. In particular, a combination of weak acid and strong base, strong acid and weak base, or weak acid and weak base is expected to exert a pH buffer action.

The polishing composition is sometimes demanded to realize a high polishing rate and at the same time to have a high cleaning removal ability. In such cases, it is preferable that an inorganic acid (including a pH adjuster) be added to the polishing composition to lower the pH (for example, pH 0.5 to 4.5) and the surface-modified colloidal silica be used as the abrasive grains. In general, a higher content of the abrasive grains results in improvement in polishing rate, but results in deterioration in cleaning removal ability. It is therefore difficult to increase the polishing rate and the cleaning removal ability at the same time. In contrast, when an inorganic acid is added to the polishing composition, the polishing rate is improved by the chemical action of the inorganic acid even if the content of the abrasive grains in the polishing composition is low. Thus, both of the cleaning removal ability and the polishing rate can be improved. In addition, the surface-modified colloidal silica can stably exert a function as abrasive grains even in a polishing composition having a lowered pH by addition of inorganic acid.

The polishing method of the present embodiment will now be described.

The polishing composition can be used in the same apparatus and conditions as those commonly used for polishing a metal material. As a polishing apparatus, a single-side polishing apparatus or a double-side polishing apparatus is generally used. In the single-side polishing apparatus, an alloy material is held using a holder, which is referred to as a carrier, a platen to which a polishing pad is pasted is pressed against one surface of the alloy material while the polishing composition is being fed, and the platen is rotated to thereby polish the surface of the alloy material. In the double-side polishing apparatus, an alloy material is held using a carrier, a platen to which a polishing pad is pasted is pressed on each of both sides of the alloy material while the polishing composition is being fed from above, and the platens are rotated in opposite directions to thereby polish the both sides of the alloy material. At this time, the alloy material is polished by the physical action by friction between the polishing pad and the polishing composition, and the alloy material and by the chemical action imparted to the alloy by the polishing composition.

The polishing conditions include the polishing load. In general, the larger the polishing load is, the higher the friction force between the abrasive grains and the alloy material becomes. As a result, mechanical processability is improved and the polishing rate is increased. The polishing load to be applied to the alloy material is not particularly limited, but is preferably 50 to 1,000 g/cm², more preferably, 100 to 800 g/cm², and further preferably, 300 to 600 g/cm². When the polishing load is in the above range, not only a sufficiently high polishing rate can be attained, but also wafer damage and generation of surface defects can be reduced.

In addition, the polishing conditions include the linear velocity. In general, the linear velocity is affected by the number of revolutions of the polishing pad, the number of revolutions of the carrier, the size of the alloy material, the number of alloy materials, and the like. When the linear velocity is high, the friction force to be loaded on the alloy material is larger, and therefore a mechanical polishing action on the alloy material is enhanced. In addition, heat generated by the friction may increase a chemical polishing action by the polishing composition. The linear velocity is not particularly limited, but is preferably 10 to 300 m/min and more preferably 30 to 200 m/min. When the linear velocity is in the above range, not only a sufficiently high polishing rate can be achieved, but also a proper friction force can be imparted to the alloy material.

The polishing pad is not limited by the material, the thickness, and physical properties such as hardness. For example, any polishing pad such as polyurethane type, non-woven fabric type and suede type pads having various hardness and thicknesses and including abrasive grains or including no abrasive grains can be used. A suede type polishing pad including no abrasive grains is preferable. Among suede type polishing pads, one that is less deformed due to pressure during processing, in other words, one that is high in hardness is more preferable. Specifically, preferable is a suede type polishing pad having a hardness of 78 or more in the hardness measurement method using TECLOCK (registered trademark), defined in Japanese Industrial Standards (JIS) S6050. The hardness of the polishing pad can be increased by using polyethylene terephthalate or a non-woven fabric for a base material.

Polishing conditions include the supply rate of the polishing composition. The supply rate of the polishing composition depends on the type of the alloy material to be polished, the type of the polishing apparatus, and other polishing conditions, but is preferably sufficient for uniformly supplying the polishing composition to the entire surfaces of the alloy material and the polishing pad.

The alloy material may also be preliminarily polished using a preliminary polishing composition before being polished using the polishing method of the present embodiment. The alloy material sometimes has scrapes, on the surface thereof, due to processing or transporting of the alloy material. Such scrapes can be removed by preliminary polishing, thereby shortening the time required for terminating a polishing step according to the present embodiment to effectively provide an excellent mirror surface.

Hereinafter, the preliminary polishing composition for use in a preliminary polishing step will be described.

The preliminary polishing composition is required to have a stronger polishing force than the polishing composition for use in the polishing method of the present embodiment. Specifically, the preliminary polishing composition preferably contains abrasive grains having a higher hardness and a larger particle size than the abrasive grains for use in the polishing method of the present embodiment.

Examples of the abrasive grains included in the preliminary polishing composition include those made of silicon carbide, aluminum oxide (alumina), zirconia, zircon, ceria, and titanium oxide, but not limited thereto. Among these abrasive grains, those made of aluminum oxide are particularly preferable. The aluminum oxide is not particularly limited, but, for example, α-alumina, δ-alumina, θ-alumina, κ-alumina, or alumina having other crystal form can be used. In addition, the aluminum oxide may include an impurity element such as silicon, titanium, iron, copper, chromium, sodium, potassium, calcium or magnesium.

When the alloy material is polished at a higher rate, alumina abrasive grains having α-alumina as a main component are preferably used. The proportion of α-alumina in the alumina abrasive grains is preferably 20% or more and more preferably 40% or more. The proportion of α-alumina in the alumina abrasive grains is determined from the integrated intensity ratio of X-ray diffraction line on the (113) face.

The average particle size of the abrasive grains included in the preliminary polishing composition is preferably 0.1 μm or more and more preferably 0.3 μm or more. When the average particle size of the abrasive grains is in the above range, the polishing rate of the alloy material is improved.

The average particle size of the abrasive grains included in the preliminary polishing composition is preferably 20 μm or less and more preferably 5 μm or less. When the average particle size of the abrasive grains is in the above range, a polished surface having low defects and small surface roughness can be easily obtained. The average particle size of the abrasive grains can be measured using, for example, a laser diffraction/scattering particle size distribution measurement apparatus, for example, “LA-950” manufactured by Horiba Ltd.

The specific surface area of the abrasive grains included in the preliminary polishing composition is preferably 20 m²/g or less. When the specific surface area of the abrasive grains is in the above range, the polishing rate of the alloy material is improved.

The specific surface area of the abrasive grains included in the preliminary polishing composition is preferably 5 m²/g or more. When the specific surface area of the abrasive grains is in the above range, a polished surface having low defects and small surface roughness can be easily obtained. Herein, the specific surface area of the abrasive grains can be measured using, for example, “Flow SorbII 2300” manufactured by Micromeritics Instrument Corporation.

The content of the abrasive grains in the preliminary polishing composition is preferably 0.5% by mass or more and more preferably 1% by mass or more. When the content of the abrasive grains is in the above range, the polishing rate of the alloy material is improved.

The content of the abrasive grains in the preliminary polishing composition is preferably 20% by mass or less and more preferably 10% by mass or less. When the content of the abrasive grains is in the above range, not only the production cost of the preliminary polishing composition can be reduced, but also scratches on the alloy surface after preliminary polishing can be reduced.

The preferable pH of the preliminary polishing composition is different depending on the type of the alloy to be polished. The pH of the preliminary polishing composition is adjusted by a known acid, base, or a salt thereof.

When an organic acid, in particular, glycolic acid, succinic acid, maleic acid, citric acid, tartaric acid, malic acid, gluconic acid or itaconic acid is used for pH adjustment of the preliminary polishing composition, the improvement in polishing rate is expected.

The embodiment may be modified as follows.

The polishing composition may also include two or more kinds of abrasive grains in any concentrations.

The polishing composition may also contain additives having a function to further enhance the polishing rate, such as complexing agents or etching agents, as necessary.

The polishing composition may also contain an additive for imparting hydrophilicity to the alloy surface after polishing. Specific examples of such an additive include water-soluble polymers such as polycarboxylic acids including polyacrylic acid and polymaleic acid, polyphosphonic acid, polysulfonic acid, polysaccharides, cellulose derivatives, ethylene oxide polymer and a vinyl polymer, and copolymers, salts and derivatives thereof. These additives can increase the wettability of the alloy surface after polishing, to thereby prevent foreign substances from being attached to the alloy surface.

The polishing composition may further contain known additives such as preservatives, antifungal agents and rust preventives, if necessary.

The polishing composition may further contain additives such as dispersing agents for improving the dispersibility of the abrasive grains and dispersing auxiliaries for facilitating redispersion of aggregates, if necessary.

The polishing composition, after being used once for polishing of the alloy, can be recovered and again used for polishing. One example of the method for reusing the polishing composition includes a method including recovering the used polishing composition discharged from the polishing apparatus once in a tank and circulating it from the tank to the polishing apparatus again for use. Such cyclic use of the polishing composition reduces the amount of the polishing composition discharged as waste liquid and reduces the amount of the polishing composition used. Such reductions are useful in that environmental load and the production cost of the alloy material are reduced.

Cyclic use of the polishing composition causes components such as silica in the polishing composition to be consumed and lost due to polishing. Therefore, the lost amount of the component, such as silica, may be supplied to the polishing composition in the cyclic use. The component to be supplied may be separately added to the polishing composition, or may be added to the polishing composition as a mixture including two or more components in any concentrations. In this case, the polishing composition is adjusted so as to be suitably recycled, thereby suitably maintaining polishing performance.

The polishing composition may also be prepared by diluting stock solution of the polishing composition with water.

The polishing composition may be of a one-component type, or a multi-component type such as a two or more-component formulation. In addition, when a polishing apparatus having a plurality of routes for supplying a polishing agent is used, the polishing composition may be formed by preparing two or more compositions in advance and mixing them in the polishing apparatus.

Examples and Comparative Examples of the present invention will now be described.

### (Test 1)

Surface-unmodified colloidal silica having an average particle size of 78 nm was diluted with water, and an oxidant was further added thereto to prepare each of the polishing compositions of Compositions 1-1 to 1-5. Polishing composition of Composition 1-6 was prepared with no oxidant added. With respect to each of the polishing compositions, the concentration and the average particle size of each colloidal silica, the type and the concentration of each oxidant, and the pH are shown in Table 2.

As alloys to be polished, an aluminum alloy, a titanium alloy, a stainless steel, and a copper alloy were prepared. Pure aluminum (1N99) was also prepared as a reference. Compositions of the alloys used are shown in Table 3. The Vickers hardness of each of elements constituting each of the alloys is shown in Table 4. These alloys were preliminarily polished using a preliminary polishing composition so that the surface roughness was in a range from 0.02 μm to 0.04 μm.

Each of the polishing compositions of Compositions 1-1 to 1-6 was used to polish each of the alloys under the polishing conditions listed in Table 1. Then, the polishing rate, the surface defects and the surface roughness of each of the alloys were evaluated.

### [Evaluation of Polishing Rate]

The weight of each of the alloys was measured before and after polishing. The polishing rate was calculated from the difference in weight before and after polishing and is shown in the “Polishing Rate” column in Table 5.

### [Evaluation of Surface Defects]

The alloy surface after polishing was visually checked under a fluorescent lamp. The results are shown in the “defects” column in Table 5. It is to be noted that in the “defects” column, “C” indicates that orange peel-like uneven defects were generated on the alloy surface, “B” indicates that orange peel-like uneven defects were slightly generated on the alloy surface, and “A” indicates that orange peel-like uneven defects were not generated on the alloy surface.

### [Evaluation of Surface Roughness]

The surface roughness (Ra) of the alloy surface after polishing was measured using SURFCOM (registered trademark) 1500DX under conditions of a measurement length of 30.0 mm and a measuring speed of 0.3 mm/sec. The results are shown in the “Ra” column in Table 5.

TABLE 1
<Polishing conditions>

Polishing machine: single-side polisher “EJ-380IN” (surface plate
diameter: 380 mm) manufactured by Engis Japan Corporation
Polishing pad: non-woven fabric polishing pad “NP225”
manufactured by Filwel Co., Ltd.
Polishing pressure: 580 g/cm² (56.9 kPa)
Surface Plate rotational rate: 50 rpm
Linear velocity: 79 m/min
Polishing time: 20 min
Supply rate of polishing composition: 50 mL/min (pouring onto
the wafer)

TABLE 2

| | Colloidal silica | | Oxidant | | |
|---|---|---|---|---|---|
| | Concen- | Average | | Concen- | |
| | tration | particle | | tration | |
| | [% by | size | | [% by | |
| | mass] | [nm] | Type | mass] | pH |
| Composition | 20.0 | 78 | Hydrogen | 0.5 | 9.9 |
| 1-1 | | | peroxide | | |
| Composition | 20.0 | 78 | Hydrogen | 0.1 | 9.9 |
| 1-2 | | | peroxide | | |
| Composition | 20.0 | 78 | Hydrogen | 0.03 | 9.9 |
| 1-3 | | | peroxide | | |
| Composition | 20.0 | 78 | Hydrogen | 0.02 | 9.9 |
| 1-4 | | | peroxide | | |
| Composition | 20.0 | 78 | Ammonium | 10 | 9.0 |
| 1-5 | | | persulfate | | |
| Composition | 20.0 | 78 | — | — | 9.9 |
| 1-6 | | | | | |

TABLE 3

| | Si | Fe | Cu | Mn | Mg | Cr | Zn | Al |
|---|---|---|---|---|---|---|---|---|
| A1200 | ≦1.00 | | ≦0.05 | ≦0.05 | — | — | ≦0.1 | 99.00 or |
| | | | | | | | | more |
| A5052 | ≦0.25 | ≦0.4 | ≦0.1 | ≦0.1 | 2.2-2.8 | 0.15-0.35 | ≦0.1 | remainder |
| 1N99 | ≦0.006 | ≦0.004 | ≦0.008 | — | — | — | — | 99.99 or |
| | | | | | | | | more |

| | Mn | Ni | Cr | Mo | Fe |
|---|---|---|---|---|---|
| SUS304 | ≦2.0 | 8.0-10.5 | 18.0-20.0 | — | remainder |
| SUS430 | ≦1.0 | ≦0.04 | 16.0-18.0 | ≦0.03 | remainder |

| | Pb | Fe | Zn | Cu |
|---|---|---|---|---|
| C2801 | ≦0.1 | ≦0.07 | remainder | 59.0-62.0 |

TABLE 4

| Element | Al | Pb | Mg | Zn | Ni | Ti | Cu | Fe | Cr | Mo | Si |
|---|---|---|---|---|---|---|---|---|---|---|---|
| Vickers | 18 | 37 | 37 | 48 | 60 | 60 | 85 | 103 | 130 | 160 | 1053 |
| hardness | | | | | | | | | | | |
| [HV] | | | | | | | | | | | |

TABLE 5

| | | | Polishing | | |
|---|---|---|---|---|---|
| | Polishing | | rate | | Ra |
| | composition | Alloy | [μm/min] | Defects | [μm] |
| Example 1-1 | Composition | SUS430 | 0.04 | A | 0.0089 |
| | 1-1 | | | | |
| Example 1-2 | Composition | SUS304 | 0.04 | A | 0.0045 |
| | 1-1 | | | | |
| Example 1-3 | Composition | C2801 | 0.21 | A | 0.0095 |
| | 1-1 | | | | |
| Example 1-4 | Composition | A5052 | 0.26 | A | 0.0072 |
| | 1-1 | | | | |
| Example 1-5 | Composition | A5052 | 0.32 | A | 0.0096 |
| | 1-2 | | | | |
| Example 1-6 | Composition | A5052 | 0.28 | A | 0.0091 |
| | 1-3 | | | | |
| Example 1-7 | Composition | A1200 | 0.26 | A | 0.0070 |
| | 1-1 | | | | |
| Example 1-8 | Composition | A1200 | 0.28 | A | 0.0077 |
| | 1-2 | | | | |
| Example 1-9 | Composition | A1200 | 0.28 | A | 0.0088 |
| | 1-3 | | | | |
| Example 1-10 | Composition | A5052 | 0.26 | A | 0.0080 |
| | 1-5 | | | | |
| Example 1-11 | Composition | A1200 | 0.26 | A | 0.0080 |
| | 1-5 | | | | |
| Example 1-12 | Composition | A1200 | 0.32 | B | 0.0151 |
| | 1-4 | | | | |
| Example 1-13 | Composition | A5052 | 0.29 | B | 0.0112 |
| | 1-4 | | | | |
| Comparative | Composition | A1200 | 0.32 | C | 0.0157 |
| Example 1-1 | 1-6 | | | | |
| Comparative | Composition | SUS430 | 0.06 | C | 0.0189 |
| Example 1-2 | 1-6 | | | | |
| Comparative | Composition | SUS304 | 0.05 | C | 0.0105 |
| Example 1-3 | 1-6 | | | | |
| Comparative | Composition | C2801 | 0.04 | C | 0.0103 |
| Example 1-4 | 1-6 | | | | |
| Comparative | Composition | A5052 | 0.05 | C | 0.0157 |
| Example 1-5 | 1-6 | | | | |
| Reference | Composition | 1N99 | 0.32 | A | 0.0080 |
| Example1-1 | 1-6 | | | | |

As shown in Table 5, generation of defects was suppressed to provide an excellent mirror surface in each of Examples 1-1 to 1-13, in which any of the polishing compositions of Compositions 1-1 to 1-5 was used, unlike each of Comparative Examples 1-1 to 1-5, in which the polishing composition of Composition 1-6 was used. In addition, when an object to be polished was not an alloy including 0.1% by mass or more of a different element as shown in Reference Example 1-1, surface defects were not generated even if the object was polished using the polishing composition of Composition 1-6.

### (Test 2)

Surface-unmodified colloidal silica having an average particle size of 17 nm, 31 nm or 78 nm was diluted with water, and an oxidant was further added thereto to prepare each of the polishing compositions of Composition 2-1 to Composition 2-6. With respect to each of the polishing compositions, the concentration and the average particle size of each colloidal silica, the type and the concentration of each oxidant, and the pH are shown in Table 6.

As alloys to be polished, aluminum alloy A5052 listed in Table 3 was prepared. This alloy was preliminarily polished using a preliminary polishing composition so that the surface roughness was in a range from 0.02 μm to 0.04 μm.

Each of the polishing compositions of Compositions 2-1 to 2-6 was used to polish the alloy under the polishing conditions listed in Table 1. Then, the polishing rate, the surface defects and the surface roughness were evaluated by the same method as in Test 1. The results thereof are shown in the “polishing rate”, “defects” and “Ra” columns in Table 7.

TABLE 6

| | Colloidal silica | | Oxidant | | |
|---|---|---|---|---|---|
| | Concen- | Average | | Concen- | |
| | tration | particle | | tration | |
| | [% by | size | | [% by | |
| | mass] | [nm] | Type | mass] | pH |
| Composition | 20.0 | 78 | Hydrogen | 0.5 | 9.9 |
| 2-1 | | | peroxide | | |
| Composition | 2.0 | 78 | Hydrogen | 0.5 | 9.9 |
| 2-2 | | | peroxide | | |
| Composition | 20.0 | 31 | Hydrogen | 0.5 | 9.9 |
| 2-3 | | | peroxide | | |
| Composition | 2.0 | 31 | Hydrogen | 0.5 | 9.9 |
| 2-4 | | | peroxide | | |
| Composition | 20.0 | 17 | Hydrogen | 0.5 | 9.9 |
| 2-5 | | | peroxide | | |
| Composition | 2.0 | 17 | Hydrogen | 0.5 | 9.9 |
| 2-6 | | | peroxide | | |

TABLE 7

| | | | Polishing | | |
|---|---|---|---|---|---|
| | Polishing | | rate | | Ra |
| | composition | Alloy | [μm/min] | Defects | [μm] |
| Example 2-1 | Composition | A5052 | 0.32 | A | 0.0072 |
| | 2-1 | | | | |
| Example 2-2 | Composition | A5052 | 0.12 | A | 0.0098 |
| | 2-2 | | | | |
| Example 2-3 | Composition | A5052 | 0.20 | A | 0.0085 |
| | 2-3 | | | | |
| Example 2-4 | Composition | A5052 | 0.09 | A | 0.0082 |
| | 2-4 | | | | |
| Example 2-5 | Composition | A5052 | 0.17 | A | 0.0075 |
| | 2-5 | | | | |
| Example 2-6 | Composition | A5052 | 0.06 | A | 0.0071 |
| | 2-6 | | | | |

As shown in Table 7, an excellent mirror surface with no surface defects was obtained in all of Examples 2-1 to 2-6. In addition, a high polishing rate can be achieved by using a polishing composition containing abrasive grains of a large average particle size or abrasive grains in a high concentration.

### (Test 3)

Colloidal silica having an average particle size of 17 nm or 31 nm and surface-modified by sulfonic acid was diluted with water, and an oxidant and a pH adjuster were further added thereto to prepare each of the polishing compositions of Compositions 3-1 and 3-3, having a pH of 2.0. For the pH adjuster, sulfuric acid was used. The polishing compositions of Compositions 3-2 and 3-4 were prepared with no pH adjuster added. With respect to each of the polishing compositions, the concentration and the average particle size of each colloidal silica, the type and the concentration of each oxidant, and the pH are shown in Table 8.

As alloys to be polished, aluminum alloy A5052 listed in Table 3 was prepared. This alloy was preliminarily polished using a preliminary polishing composition so that the surface roughness was in a range from 0.02 μm to 0.05 μm.

Each of the polishing compositions of Compositions 3-1 to 3-4 was used to polish the alloy under the polishing conditions listed in Table 1. Then, the polishing rate, the surface defects and the surface roughness were evaluated by the same method as in Test 1. The results thereof are shown in the “polishing rate”, “defects” and “Ra” columns in Table 9.

TABLE 8

| | Colloidal silica | | Oxidant | | |
|---|---|---|---|---|---|
| | Concen- | Average | | Concen- | |
| | tration | particle | | tration | |
| | [% by | size | | [% by | |
| | mass] | [nm] | Type | mass] | pH |
| Composition | 2.0 | 31 | Hydrogen | 0.5 | 2.0 |
| 3-1 | | | peroxide | | |
| Composition | 2.0 | 31 | Hydrogen | 0.5 | 6.8 |
| 3-2 | | | peroxide | | |
| Composition | 2.0 | 17 | Hydrogen | 0.5 | 2.0 |
| 3-3 | | | peroxide | | |
| Composition | 2.0 | 17 | Hydrogen | 0.5 | 6.8 |
| 3-4 | | | peroxide | | |

TABLE 9

| | | | Polishing | | |
|---|---|---|---|---|---|
| | Polishing | | rate | | Ra |
| | composition | Alloy | [μm/min] | Defects | [μm] |
| Example 3-1 | Composition | A5052 | 0.20 | A | 0.0079 |
| | 3-1 | | | | |
| Example 3-2 | Composition | A5052 | 0.10 | A | 0.0076 |
| | 3-2 | | | | |
| Example 3-3 | Composition | A5052 | 0.18 | A | 0.0072 |
| | 3-3 | | | | |
| Example 3-4 | Composition | A5052 | 0.08 | A | 0.0075 |
| | 3-4 | | | | |

As shown in Table 9, an excellent mirror surface with no surface defects was obtained in all of Examples 3-1 to 3-4. In addition, the polishing speed was improved in each of

Examples 3-1 and 3-3, in which the pH of the polishing composition was adjusted to 2.0.

1. A method for polishing an alloy material including a main component and 0.1% by mass or more of an element having a Vickers hardness (HV) different from that of the main component by 5 or more, the method comprising:
preparing the alloy material; and
polishing a surface of the alloy material by using a polishing composition containing abrasive grains and an oxidant.

2. The method for polishing an alloy material according to claim 1, wherein the alloy material is an aluminum alloy, a titanium alloy, a stainless steel, a nickel alloy, or a copper alloy.

3. The method for polishing an alloy material according to claim 1, wherein the oxidant is hydrogen peroxide.

4. The method for polishing an alloy material according to claim 1, wherein the abrasive grains are colloidal silica.

5. The method for polishing an alloy material according to claim 1, further comprising preliminarily polishing the alloy material by using a preliminary polishing composition.

6. A method for producing an alloy material, comprising polishing an alloy material by using the method for polishing an alloy material according to claim 1.

7. An alloy material produced by using the production method according to claim 6.

8. The method for producing an alloy material according to claim 6, wherein the alloy material is an aluminum alloy, a titanium alloy, a stainless steel, a nickel alloy, or a copper alloy.
